(19) United States
(12) Patent Application Publication
(10) Pub. No.: US 2025/0158673 A1
(43) Pub. Date: May 15, 2025

(54) METHODS AND SYSTEMS FOR PRECODING MATRIX INDICATOR GENERATION

(71) Applicant: Telefonaktiebolaget LM Ericsson (publ), Stockholm (SE)

(72) Inventors: Ang Feng, Solna (SE); Hao Zhang, Guangzhou (CN); Christian Braun, Vallentuna (SE); Georgy Levin, Ottawa (CA)

(21) Appl. No.: 18/834,646

(22) PCT Filed: Feb. 17, 2022
(86) PCT No.: PCT/CN2022/076548

§ 371 Date: Jul. 31, 2024

(51) Int. Cl. H04B 7/0456; H04B 7/06

(52) U.S. Cl. CPC H04B 7/0456; H04B 7/0626

(57) ABSTRACT

A method of precoding matrix indicator, PMI, generation for channel state information, CSI, compression in a communication system comprising a first radio transceiver device, RTD, and a second RTD, the method comprising: transmitting, from the second RTD to the first RTD, a reference signal; receiving, at the first RTD from the second RTD, the reference signal; estimating, at the first RTD, CSI based on the received reference signal; generating, at the first RTD, a PMI to perform CSI compression, wherein the PMI indicates a precoding matrix, selected from among a codebook of precoding matrices, based on orthogonal matching pursuit, OMP, processing of the estimated CSI; generating, at the first RTD, a compressed CSI based on the generated PMI for transmission to the second RTD; and transmitting the compressed CSI from the first RTD to the second RTD.

### TECHNICAL FIELD

Embodiments of the present disclosure relate to methods and systems of generating a precoding matrix indicator (PMI) for channel state information (CSI) compression, and in particular methods and systems for efficiently identifying a suitable PMI for CSI compression.

### BACKGROUND

In current 5G/4G wireless network, channel state information (CSI) is important in many areas such as link adaptation, multi-user scheduling, and beamforming, for example. In general, CSI is easier to be acquired at a receiver (RX) side rather than at a transmitter (TX) side.

In time division duplex (TDD) systems, reciprocity of propagation channels allows for a TX CSI to be deduced by a RX CSI directly. However, in frequency division duplex (FDD) systems, since propagation channels are not reciprocal, a user equipment (UE) must feed the CSI back to a base station (BS). The true CSI is not able to be fed back to the TX side because high overhead is needed in the feedback resources (e.g. UL channel). Instead, in FDD systems, codebook schemes are provided which use a precoding matrix indicator (PMI) to represent the CSI. The 3GPP standards defines a set of codebooks that are known to both BS and UE. Once a UE estimates a CSI, it selects a precoding matrix that is closest to the estimated CSI, after which the UE sends an index for the selected precoding matrix to the BS. This is a method of transmitting the CSI with high compression of information thereby reducing the needed resources.

There are several proposals in the 3GPP standards to ensure accuracy of codebooks. With type I codebook, the spatial domain is split into N₁O₁×N₂O₂ beam vectors (where N₁ and N₂ are numbers of antennas in azimuth and elevation, respectively, and O₁ and O₂ are oversample factors of beams in azimuth and elevation, respectively) by a 2D discrete Fourier transform (DFT) operation. For dual-polarisation antennas, quadrature phase shift keying (QPSK) based phase rotation is applied between two polarisations, and therefore there are a total of 4N₁O₁×N₂O₂ beam vectors in one codebook.

However, as more antennas are deployed to support more multi-user multiplexing in the spatial domain, more precise CSI feedback is required. For this reason, the TS 38.214 V15.13.0 “NR; Physical layer procedure for data”, available at https://portal.3gpp.org/desktopmodules/Specifications/SpecificationDetails.aspx?sp ecificationld=3216, as of 28 Jan. 2022, introduced type II codebook. Unlike type I codebook, type II codebook uses a linear combination of multiple beams. The combined beam may be expressed as illustrated in equation (1), below:

$${w}_{r , l} = {\sum }_{i = 0}^{L - 1} {b}_{{k}_{1} , {k}_{2}}^{( i )} {p}_{r , l , i}^{( 1 )} {p}_{r , l , i}^{( 2 )} {c}_{r , l , i} \qquad ( 1 )$$

where:
L denotes the number of beams in one beam cluster (and L is configurable from [0, 1, 2, 4]);
r=[0, 1] which denotes two polarisations;
l denotes the layer, up to rank=2;
bₖ_{₁}_{,k}_{₂}⁽ⁱ⁾ denotes the beam weight with index of [k₁, k₂], which is generated in a similar manner to the type I codebook;
p_{r,l,i}⁽¹⁾p_{r,l,i}⁽²⁾, c_{r,l,i} is the complex coefficient of the linear combination. To reduce the overhead, the complex number is further expressed in polar coordinates as amplitude and phase. Phase is denoted by c_{r,l,i}. Amplitude is further divided into two parts, where p_{r,l,i}⁽¹⁾ is the amplitude for wideband (WB) and, p_{r,l,i}⁽²⁾ is the amplitude variations for each subband (SB). In an initial version, c_{r,l,i} is quantised as 8 phase shift keying (PSK) with 3 bits, WB p_{r,l,i}⁽¹⁾ is quantised with 3 bits, and SB p_{r,l,i}⁽²⁾ is quantised with 1 bit.

Compared to type I codebook, type II codebook performance may be improved by up to 30%. This improvement is provided by finer spatial resolution in type II codebook.

Enhanced type II codebook is introduced in TS 38.214 V16.6.0 “Physical layer procedures for data” by the 3rd Generation Partnership Project (3GPP), available at https://portal.3gpp.org/desktopmodules/Specifications/SpecificationDetails.aspx?sp ecificationld=3216 as of 28 Jan. 2022, section 5.2.2.2.5, to provide the following updates to definitions:
the number of beams (i.e. L in equation (1), above) is updated from up to 4 beams to up to 6 beams;
the wideband amplitude coefficient resolution is updated from two levels to 14 levels with 1.5 dB step increases;
the subband amplitude coefficient resolution is updated from two levels to seven levels with 3 dB step increases;
the phase coefficient levels are increased to 16 (4 bits) as defined by c_{l,i,f}∈{0, . . . , 15} in 3GPP 38.214 V16.6, section 5.2.2.2.5.

Further details of the above definitions for enhanced type II codebook are provided by Table 5.2.2.2.5-1, Table 5.2.2.2.5-2 and Table 5.2.2.2.5-3, below. In the mapping illustrated in Table 5.2.2.2.5-1, the values of L, β and pᵥ are determined by the higher layer parameter “paramCombination-r16”. Mapping from amplitude coefficient k_{l,p}⁽¹⁾ to amplitude coefficient p_{l,p}⁽¹⁾ is illustrated in Table 5.2.2.2.5-2, and, mapping from amplitude coefficient k_{l,i,f}⁽²⁾ to amplitude coefficient p_{l,i,f}⁽¹⁾ is illustrated in Table 5.2.2.2.5-3 (where i_{2,3,l} and i_{2,4,l} are amplitude coefficient indicators).

TABLE 5.2.2.2.5-1
Codebook parameter configurations for L, β and p_{υ}

| | | p_{υ} | | |
|---|---|---|---|---|
| paramCombination-r16 | L | υ ∈ {1, 2} | υ ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

TABLE 5.2.2.2.5-2
Mapping of elements of i_{2,3,l}: k_{l,p}⁽¹⁾ to p_{l,p}⁽¹⁾

| k_{l,p}⁽¹⁾ | p_{l,p}⁽¹⁾ |
|---|---|
| 0 | Reserved |
| 1 | $\frac{1}{\sqrt{128}}$ |
| 2 | ${( \frac{1}{8192} )}^{\frac{1}{4}}$ |
| 3 | $\frac{1}{8}$ |
| 4 | ${( \frac{1}{2048} )}^{\frac{1}{4}}$ |
| 5 | $\frac{1}{2 \sqrt{8}}$ |
| 6 | ${( \frac{1}{512} )}^{\frac{1}{4}}$ |
| 7 | $\frac{1}{4}$ |
| 8 | ${( \frac{1}{128} )}^{\frac{1}{4}}$ |
| 9 | $\frac{1}{\sqrt{8}}$ |
| 10 | ${( \frac{1}{32} )}^{\frac{1}{4}}$ |
| 11 | $\frac{1}{2}$ |
| 12 | ${( \frac{1}{8} )}^{\frac{1}{4}}$ |
| 13 | $\frac{1}{\sqrt{2}}$ |
| 14 | ${( \frac{1}{2} )}^{\frac{1}{4}}$ |
| 15 | 1 |

TABLE 5.2.2.2.5-3
Mapping of elements of i_{2,4,l}: k_{l,i,f}⁽²⁾ to p_{l,i,f}⁽²⁾

| k_{l,i,f}⁽²⁾ | p_{l,i,f}⁽²⁾ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

In typical wireless networks, for beamforming to perform as expected, an antenna array should be well calibrated using a function referred to as Antenna Calibration (AC). Typically, AC is done at the BS side only, either by a BS internal coupler network (CN), or by mutual coupling (MC) amongst antennas. However, in an active antenna system (AAS), it is difficult to mitigate antenna error thoroughly. That is, at an AAS site, the CSI may include not just impairments due to propagation channels but also impairments due to radio hardware and antennas. Typically, two impairments are summed together and entitled as radio channels.

Direction-of-Arrival (DOA) based AC may be used to calibrate antennas with the assistance of a UE. The method is also known as in-field AC. However, in-field AC requires a BS to acquire the full CSI, and as mentioned above, the acquisition of TX CSI is complicated.

Existing methods of obtaining the TX CSI by CSI feedback only consider the calibrated radio without or with relatively small AC error. U.S. Pat. No. 10,411,779B2 proposes an in-field AC with CSI feedback, however, such a method may not be not compliant with the latest 3GPP released type II codebook.

Although AC may work well, it is not infallible. Unfortunately, the AC error may be difficult to evaluate in the field. There are many factors that may cause AC failure, for example, improper assembly of AAS products, interference from the external environment, or malfunction of certain components. The consequences of AC failure may include service issues or correspondingly poor user experiences.

By checking the quality of beamforming, further information on AC status may be acquired. However, many unknown factors may also cause degradation of beamforming, not just AC. Even though it is known that beamforming is deteriorated by AC, it may be difficult to fix the AC error by existing methods.

In current 3GPP standard, a portion of the CSI information is lost due to the constraint of codebook design. With reference to a typical communication system illustrated in FIG. 1, the loss of CSI information may be caused by one or more of the following factors:

1. H_{BS}: channel information of the BS TX—this includes the channel information which may be impaired for a single or for multiple radio TX antenna branches of the BS.

2. H_{OTA}: channel information of the over-the-air (OTA) channel—this includes
detail information of the OTA channel, such as a UE position in azimuth and elevation. A PMI may only provide rough information about the UE position;
characteristics of the OTA channel, such as line-of-sight (LOS), none-line-of-sight (NLOS), and angle spread. A PMI may only describe the LOS channel, other information would be excluded.

3. H_{UE}: channel information of UE RX—this includes the channel information which may be impaired for a single or for multiple RX antenna branches of the UE.

The loss of such information may cause the following problems:
Loss of H_{BS} would prevent the BS from utilising the TX CSI to perform AC. Therefore, the BS needs to send self-calibration signals into the radio branches to measure the H_{BS}. The self-calibration signals would have negative impact on traffic (e.g. interruption to traffic). In addition, the BS would need dedicated hardware designed to support such calibration procedure, which would increase the cost of the system.
Loss of H_{OTA} would prevent the BS from utilising the OTA channel info to perform enhanced beamforming or MIMO. The uplink measurement on TDD might be employed to mitigate this issue. But, it is still problematic in FDD, because FDD radios have different channel characteristics in UL and DL.
Loss of H_{UE} would prevent BS to assist certain UE functions (e.g. empowering BS to monitor UE status).

### SUMMARY

It is an object of the present disclosure to provide methods and systems of identifying a suitable PMI for compressing CSI from among a codebook of precoding matrices.

Furthermore, it is desired to introduce new features to current 3GPP type II codebook to avoid loss of information and to empower all functionalities mentioned above.

Aspects of embodiments provide a communication systems, methods and computer programs which at least partially address one or more of the challenges discussed above.

An aspect of the disclosure provides a method of precoding matrix indicator, PMI, generation for channel state information, CSI, compression in a communication system comprising a first radio transceiver device, RTD, and a second RTD. The method comprises transmitting, from the second RTD to the first RTD, a reference signal. The method further comprises receiving, at the first RTD from the second RTD, the reference signal. The method further comprises estimating, at the first RTD, CSI based on the received reference signal. The method further comprises generating, at the first RTD, a PMI to perform CSI compression, wherein the PMI indicates a precoding matrix, selected from among a codebook of precoding matrices, based on orthogonal matching pursuit, OMP, processing of the estimated CSI. The method further comprises generating, at the first RTD, a compressed CSI based on the generated PMI for transmission to the second RTD. The method further comprises transmitting the compressed CSI from the first RTD to the second RTD. The method further comprises receiving, at the second RTD from the first RTD, the compressed CSI.

Advantageously, by using OMP processing to generate a PMI, a suitable PMI for use in CSI compression is quickly and accurately performed. That is, a precoding matrix which produces a compressed CSI that meets a certain CSI compression requirement (e.g. the compressed CSI being below a maximum error threshold) may be quickly identified using the OMP processing. In certain aspects of the disclosure, the certain CSI compression requirement may be met using a single suitable precoding matrix, in which case the PMI may be finalised and no further processing would be required for PMI generation (i.e. providing improved processing efficiency). On the other hand, typical methods of PMI generation may require each available precoding matrix to be processing before a suitable precoding matrix may be identified.

Optionally, the OMP processing may comprise identifying a suitable precoding matrix, from among the codebook of precoding matrices, which provides the smallest CSI compression error.

Advantageously, by using OMP processing to identify at least one suitable precoding matrix to be indicated in the PMI, CSI compression is quickly and accurately performed.

Optionally, the OMP processing may comprise updating the PMI to comprise a matrix indicator associated with the suitable precoding matrix.

Advantageously, by using a matrix indicator to indicate a suitable precoding matrix in the PMI, rather than using the entire suitable precoding matrix, signalling load is reduced and signalling efficiency is thereby improved.

Optionally, the OMP processing may comprise N processing iterations, where N is a positive integer. Each nth iteration of the OMP processing may comprise identifying an nth precoding matrix, from among the precoding matrices in an n−1th codebook of precoding matrices, which provides the greatest reduction in CSI compression error when combined with previously identified precoding matrices. The OMP processing may further comprise generating an nth codebook of precoding matrices by removing the nth precoding matrix from the n−1th codebook.

Advantageously, by identifying additional suitable precoding matrices for each nth iteration, the OMP processing may continue to identify additional precoding matrices until the certain CSI compression requirement is met (e.g. the compressed CSI being below a maximum error threshold). Therefore, in this way, the OMP processing will continue performing processing iterations until a suitable compressed CSI may be generated, after which the OMP processing may terminate. Therefore, the OMP processing continues only until CSI compression requirements have been met, which thereby avoids any unnecessary additional processing of further precoding matrices.

Furthermore, by removing the nth precoding matrix from the n−1th codebook, the volume of OMP processing may be reduced as the number of N OMP iterations increases, because the codebook becomes smaller after each iteration.

Another aspect of the disclosure provides a communication system comprising a first radio transceiver device, RTD, and a second RTD, the communication system configured to generate a precoding matrix indicator, PMI, for channel state information, CSI, compression. The first RTD comprises processing circuitry and a memory containing instructions executable by the processing circuitry. The first RTD is operable to receive, from a second RTD, a reference signal. The first RTD is further operable to estimate CSI based on the received reference signal. The first RTD is further operable to generate a PMI to perform CSI compression, wherein the PMI indicates a precoding matrix, selected from among a codebook of precoding matrices, based on orthogonal matching pursuit, OMP, processing of the estimated CSI. The first RTD is further operable to generate a compressed CSI based on the generated PMI for transmission to the other RTD. The first RTD is further operable to transmit the compressed CSI to the second RTD. The second RTD comprises processing circuitry and a memory containing instructions executable by the processing circuitry. The second RTD is operable to transmit, to the first RTD, the reference signal. The second RTD is further operable to receive, from the first RTD, the compressed CSI.

Another aspect of the disclosure provides a computer-readable medium comprising instructions which, when executed on a computer, cause the computer to perform a method of PMI generation for CSI compression.

Further aspects provide apparatuses and computer-readable media comprising instructions for performing the methods set out above, which may provide equivalent benefits to those set out above.

### BRIEF DESCRIPTION OF DRAWINGS

For a better understanding of the present disclosure, and to show how it may be put into effect, reference will now be made, by way of example only, to the accompanying drawings, in which:

FIG. 1 is a schematic diagram illustrating a typical communication system;

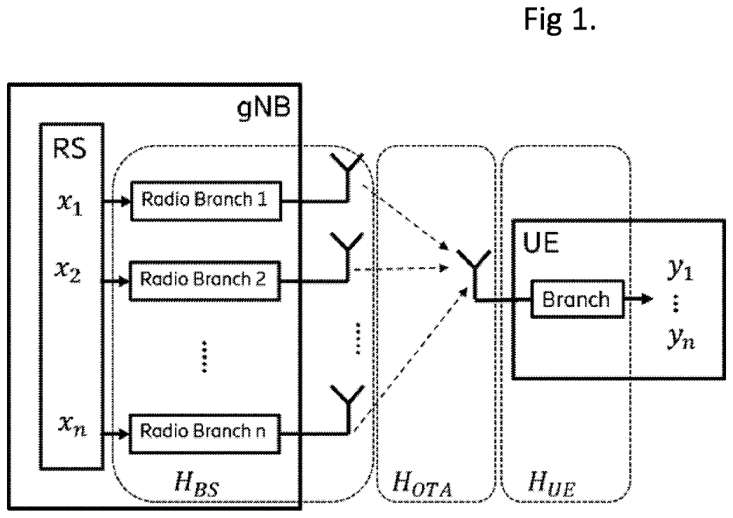

FIG. 2 is a flowchart illustrating a method of PMI generation for CSI compression in accordance with embodiments;

FIG. 3A is a schematic diagram of a communication system for generating a PMI for CSI compression in accordance with embodiments;

FIG. 3B is another schematic diagram of a communication system for generating a PMI for CSI compression in accordance with embodiments;

FIG. 4 is a schematic diagram illustrating another communication system according to embodiments;

FIG. 5 is a graphical representation of simulation results for NMSE of residual errors;

FIG. 6 is another graphical representation of simulation results for NMSE of residual error;

FIG. 7 is a graphical representation of simulation results illustrating the impact of quantisation of A_{r,l,i} and θ_{r,l,i}; and

FIG. 8 is a graphical representation of simulation results illustrating estimated AC error in a case where AoD=−33°, ZoD=5° and the initial AC error=180°.

### DETAILED DESCRIPTION

The following sets forth specific details, such as particular embodiments for purposes of explanation and not limitation. It will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology may additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Embodiments of the present disclosure provide methods and systems of identifying a suitable PMI for compressing CSI from among a codebook of precoding matrices.

In the following description, the terminology RTD will be used to describe network nodes and UEs within a communication system. It will be understood that when the terminology of RTD is used in the context of downlink communication, a first RTD may be a UE and a second RTD may be a network node. It will also be understood that when the terminology RTD is used in the context of uplink communication, a first RTD may be a network node and a second RTD may be a UE.

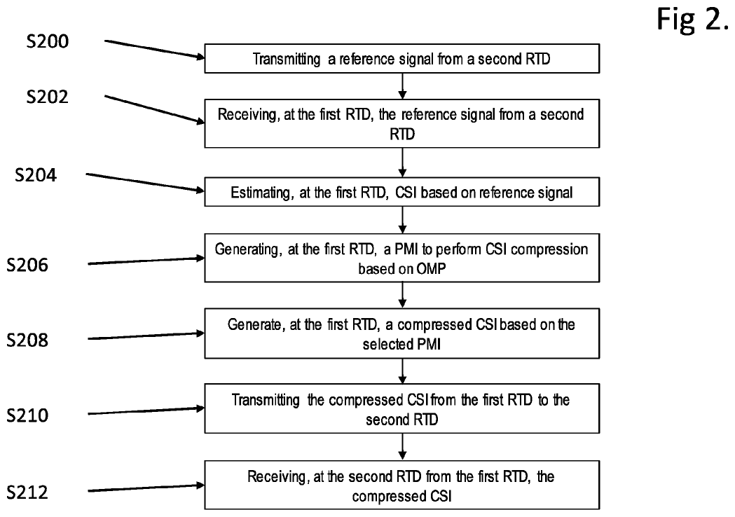

FIG. 2 is a flowchart illustrating a method of PMI generation for CSI compression performed by a communication system comprising a first RTD (e.g. a UE, in the case of downlink transmission, or a network node, in the case of uplink transmission). In particular, the first RTD uses orthogonal matching pursuit (OMP) processing in order to identify a suitable PMI for CSI compression.

It will be understood that the method illustrated in FIG. 2 may be used to generate plural PMIs for a communications system comprising plural UEs and plural network nodes.

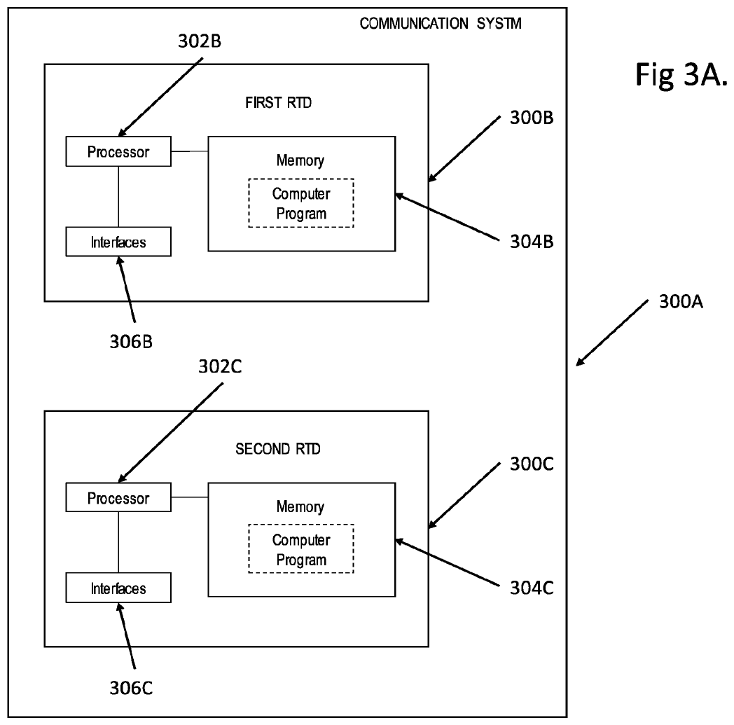

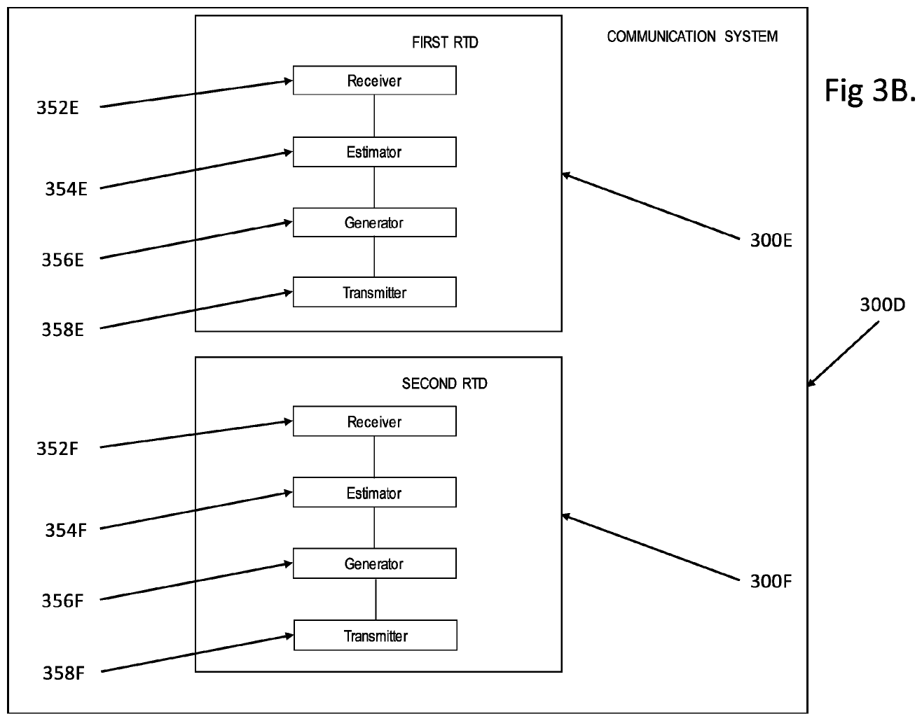

FIGS. 3A and 3B show communication systems 300A and 300D in accordance with certain embodiments. The communication systems 300A and 300D are examples of devices that may perform the method of FIG. 2. Communication systems 300A and 300B may be, for example, 3GPP 5G networks (i.e. 5th generation new radio (5G NR) networks). Communication system 300A comprises first RTD 300B and second RTD 300C. Communication system 300D comprises first RTD 300E and second RTD 300F.

In step S200, the second RTD 300C, 300F (e.g. a network node, in the case of downlink transmission, or a UE, in the case of uplink transmission) transmits a reference signal to the first RTD 300B, 300E (e.g. a UE, in the case of downlink transmission, or a network node, in the case of uplink transmission). In step S202, the reference signal is received at the first RTD 300B, 300E from the second RTD 300C, 300F. Transmitting the reference signal may be performed, for example, by a processor 302C of the second RTD 300C running a program stored on a memory 304C in conjunction with interfaces 306C, or may be performed by a transmitter 358F of the second RTD 300F. Receiving the reference signal may be performed, for example, by a processor 302B of the first RTD 300B running a program stored on a memory 304B in conjunction with interfaces 306B, or may be performed by a receiver 352E of the first RTD 300E.

Depending on whether uplink of downlink communication is being used, the reference signal may be either a CSI reference signal (CSI-RS) or a sounding reference signal (SRS). That is, during downlink communication, the claimed method generates a PMI for CSI compression based on a CSI-RS. Whereas, during uplink communication, the claimed method generates a PMI for CSI compression based on a SRS.

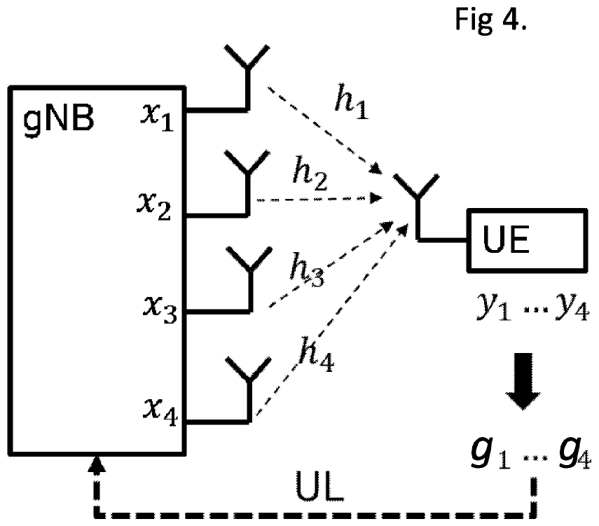

In step S204, a CSI is estimated at the first RTD 300B, 300E based on the reference signal received from the second RTD 300C, 300F (i.e. channel estimation). Further details of how CSI estimation is performed is provided below with reference to FIG. 4, in the section titled RS SIGNAL AND CSI ESTIMATION. Estimating the CSI may be performed, for example, by the processor 302B of the first RTD 300B running a program stored on the memory 304B in conjunction with the interfaces 306B, or may be performed by an estimator 354E of the first RTD 300E.

In step S206, a PMI is generated at the first RTD 300B, 300E to perform CSI compression based on OMP processing of the estimated CSI. The PMI is generated to indicate at least one precoding matrix selected from among a codebook of precoding matrices. The codebook of precoding matrices may be based on the type II codebook or the enhanced type II codebook discussed above in relation to TS 38.214 V16.6 (i.e. the codebook of precoding matrices may comprise standard compliant matrices). Generating the PMI may be performed, for example, by the processor 302B of the first RTD 300B running a program stored on the memory 304B in conjunction with the interfaces 306B, or may be performed by a generator 356E of the first RTD 300E.

The estimated CSI may comprise radio hardware impairments (e.g. non-linearity due to power amplifier, quadrature error due to a homodyne transceiver and electrothermal noise), multipath fading channels (e.g. multipath scattering, reflection effects, time dispersion and Doppler shifts), and antenna error from AC.

According to certain embodiments, AC compensation parameters may be determined at the second RTD 300C, 300F based on the antenna error from AC, which may be included in the estimated CSI transmitted to the second RTD 300C, 300F from the first RTD 300B, 300E. AC compensation parameters may be used to correct any error in the antenna due to imperfect AC.

In step S208, a compressed CSI is generated at the first RTD 300B, 300E based on the PMI generated in step S206. The compressed CSI is transmitted to the second RTD 300C, 300F. In certain embodiments, the compressed CSI is represented by the PMI such that the second RTD 300C, 300F may determine the estimated CSI using the precoding matrix indicated in the received PMI. Generating the compressed CSI may be performed, for example, by the processor 302B of the first RTD 300B running a program stored on the memory 304B in conjunction with the interfaces 306B, or may be performed by a generator 356E of the RTD 300E.

In step S210, the first RTD 300B, 300E transmits the compressed CSI to the second RTD 300C, 300F. In step S212, the compressed CSI is received at the second RTD 300C, 300F from the first RTD 300B, 300E. Transmitting the compressed CSI may be performed, for example, by the processor 302B of the first RTD 300B running a program stored on the memory 304B in conjunction with the interfaces 306B, or may be performed by a transmitter 358E of the first RTD 300E. Receiving the compressed CSI may be performed, for example, by the processor 302C of the second RTD 300C running a program stored on the memory 304C in conjunction with the interfaces 306C, or may be performed by a receiver 352F of the second RTD 300F.

It will be understood that the PMI may indicate one or more precoding matrices selected from among the codebook of precoding matrices. That is, the OMP processing may be performed iteratively until sufficient precoding matrices are identified in the PMI to perform adequate CSI compression. For example, according to certain embodiments, a single iteration of OMP processing may be required if a single precoding matrix (i.e. the suitable precoding matrix identified during the first iteration of OMP processing) may be used to generate the compressed CSI within a certain error tolerance. In other embodiments, the OMP processing may be performed for N iterations (wherein N is a positive integer) to identify plural precoding matrices (i.e. one suitable precoding matrix from each OMP iteration), where the OMP processing continues until the compressed CSI may be generated within a certain error tolerance using the plural precoding matrices (e.g. in a final PMI). Embodiments in which a single iteration of OMP processing is performed will now be described in more detail.

The OMP processing may begin by identifying a suitable precoding matrix, from among the codebook of precoding matrices, which provides the smallest CSI compression error from among the codebook of precoding matrices. The CSI compression error may define the difference between the estimated CSI and a resulting compressed CSI generated using the identifies suitable precoding matrix. The CSI compression error may be determined based on the estimated CSI (e.g. the CSI compression error may be generated based on the reduction in the estimated CSI provided by the identified precoding matrices).

The suitable precoding matrix may be identified by correlating the estimated CSI with each precoding matrix from among the codebook of precoding matrices. That is, each precoding matrix within the codebook may be correlated with the estimated CSI in order to identify the precoding matrix with the highest correlation. For each correlated precoding matrix, a magnitude of CSI compression error provided by the corresponding correlated precoding matrix may be determined (i.e. a value indicating the difference between the estimated CSI and the resulting compressed CSI using a corresponding precoding matrix is determined). The precoding matrix which provides the smallest CSI compression error, based on the determined magnitudes, may be identifies as the suitable precoding matrix. The smallest CSI compression error may be determined by comparing the magnitudes against each other and identifying the smallest magnitude as the smallest CSI compression error.

Once the suitable precoding matrix is identified, an updated PMI may be generated which comprises a matrix indicator associated with the suitable precoding matrix. Advantageously, the PMI comprises a matrix indicator, rather than the entire suitable precoding matrix, in order to reduce signalling load and improve signalling efficiency.

According to certain embodiments, the precoding matrices within the codebook of precoding matrices may have unique indicators (alternatively referred to as indices) such that each precoding matrix may be uniquely identified based on its indicator alone. Furthermore, in some embodiments, the method may determine PMI coefficients of the generated PMI upon completion of the OMP processing. The PMI coefficients may be transmitted from the first RTD 300B, 300E to the second RTD 300C, 300F in addition to the PMI, which itself comprises matrix indicators. Advantageously, by calculating the PMI coefficients after the OMP processing has completed, rather than during the OMP processing, the efficiency with which a PMI is generated may be improved.

In certain embodiments, the method further comprises generating an updated codebook of precoding matrices by removing the suitable precoding matrix from the codebook. That is, the updated precoding matrix may comprise all the precoding matrices from the original codebook except the identified suitable precoding matrix, which is removed. Furthermore, the updated codebook of precoding matrices may be generated by projecting all precoding matrices remaining in the updated codebook (after the suitable precoding matrix has been removed) onto the identified suitable precoding matrix.

In a similar manner, the method may further comprise projecting the estimated CSI onto the identified suitable precoding matrix.

Projecting may be performed by a projection matrix generated from the identified suitable precoding matrix. In the context of the present disclosure, the terminology “projecting” may be understood to be a linear algebra term, as illustrated in equation (2) below. In particular, for any matrix A, matrix P is the projection matrix of matrix A and matrix AH is a conjugate transpose matrix of matrix A.

$$P = A * {A}^{H} \qquad ( 2 )$$

Therefore, in the step of projecting remaining precoding matrices in the updated codebook onto the suitable precoding matrix, each remaining precoding matrix may be multiplied with the projection matrix generated by the suitable precoding matrix substituted for A in equation (2) above.

Similarly, in the step of projecting the estimated CSI onto the suitable precoding matrix, an estimated CSI matrix may be multiplied with the projection matrix generated by the suitable precoding matrix substituted for A in equation (2) above.

The OMP processing may further comprise identifying the magnitude of CSI compression error provided by the suitable precoding matrix as a CSI error value. In other words, a value indicating the difference between the estimated CSI and the resulting compressed CSI using the suitable precoding matrix is defined as the CSI error value. The CSI error value may be used to terminate the OMP processing when a final PMI should be generated and transmitted from the first RTD 300B, 300E to the second RTD 300C, 300F. For example, the final PMI may be generated when the CSI error value is below a maximum error threshold. The maximum error threshold may be predetermined to be, for example, a value of normalized mean squared error, NMSE, less then −40 dB. The final PMI may comprise at least the matrix indicator associated with the suitable precoding matrix.

Embodiments in which OMP processing may be performed for N iterations (wherein N is a positive integer) to identify plural precoding matrices (i.e. one suitable precoding matrix from each OMP iteration) will now be described in more detail.

The OMP processing may comprise N processing iterations, where N is a positive integer. The number of iteration N may depend on the number of precoding matrices required to reduce the CSI error value to below a maximum threshold, for example, a value of NMSE less than −40 dB. Additionally or alternatively, the number of iterations N may be restricted by the maximum number of iterations allowed by the OMP processing (e.g. a maximum number of iterations set by the OMP processing itself).

Each nth iteration of the N processing iterations may begin by identifying an nth precoding matrix, from among the precoding matrices in an n−1th codebook of precoding matrices, which provides the greatest reduction in CSI compression error when combined with previously identified precoding matrices. The nth precoding matrix may alternatively be referred to as an nth suitable precoding matrix. The CSI compression error may define the difference between the estimated CSI and a resulting compressed CSI generated using the identified nth precoding matrix in combination with previously identified matrices. The CSI compression error may be determined based on the estimated CSI (e.g. the CSI compression error may be generated based on the reduction in the estimated CSI provided by the identified precoding matrices).

The method may determine which remaining precoding matrix provides the greatest reduction in CSI compression error (when combined with previously identified matrices in a previous PMI (i.e. an n−1th PMI)) by comparing newly determined CSI compression errors with a previous CSI compression error of the n−1th PMI. That is, each remaining precoding matrix may be combined with the precoding matrices already defined in the n−1th PMI in order to determine a new CSI compression error for each remaining precoding matrix. The new CSI compression errors may then be compared to the CSI compression error provided by the preceding matrices indicated in the n−1th PMI only. The nth precoding matrix may be identified as the precoding matrix which provides the greatest reduction in CSI compression error compared to the CSI compression error provided by the matrices of the n−1th PMI. It will be understood that the n−1th PMI may include zero precoding matrices for the first iteration of the OMP processing, in which case the first precoding matrix of the first iteration may be identified as the precoding matrix which provides the smallest CSI compression error from among the codebook of precoding matrices, as discussed above.

The nth precoding matrix may be identified by correlating the estimated CSI with each precoding matrix in the n−1th codebook of precoding matrices. That is, each precoding matrix within the n−1th codebook may be correlated with the estimated CSI in order to identify the precoding matrix with the highest correlation. For each correlated precoding matrix, a magnitude of CSI compression error provided by the corresponding correlated precoding matrix may be determined (i.e. a value indicating the difference between the estimated CSI and the resulting compressed CSI using a corresponding precoding matrix is determined). The precoding matrix which provides the greatest reduction in CSI compression error when combined with the precoding matrices previously defined in the n−1th PMI (compared to the CSI compression error provided by the matrices of the n−1th PMI only), based on the determined magnitudes, may be identified as the nth precoding matrix. The greatest reduction in CSI compression error may be determined by comparing the magnitudes against each other and identifying the smallest magnitude as the greatest reduction in CSI compression error.

Upon identifying the nth precoding matrix from among the n−1th codebook, the OMP processing may proceed to generate an nth codebook of precoding matrices by removing the nth precoding matrix from the n−1th codebook of precoding matrices. Accordingly, for an nth iteration of the OMP processing, an nth codebook may be generated by removing the nth precoding matrix (i.e. the suitable precoding matrix identified during the nth iteration) from the n−1th codebook (i.e. the codebook generated during the n−1th iteration). In this way, certain embodiments provide the advantage that the volume of OMP processing is reduced as the number of N OMP iterations increases, because the codebook becomes smaller after each iteration. It will be understood that the n−1th codebook may include all available precoding matrices within a codebook for the first iteration of the OMP processing, in which case the n−1th codebook may be the entire codebook of precoding matrices.

The nth codebook of precoding matrices may be generated by projecting all precoding matrices remaining in the nth codebook (after the nth precoding matrix has been removed) onto the identified nth precoding matrix.

In a similar manner, the method may further comprise projecting the estimated CSI onto the identified nth precoding matrix.

Projecting may be performed by a projection matrix generated from the identified nth precoding matrix. In the context of the present disclosure, the terminology “projecting” may be understood to be a linear algebra term, as discussed above in relation to equation (2).

Once the nth precoding matrix is identified, an updated PMI may be generated which comprises an nth matrix indicator associated with the nth precoding matrix. Advantageously, the PMI comprises an nth matrix indicator, rather than the entire nth precoding matrix, in order to reduce signalling load and improve signalling efficiency.

In some embodiments, the precoding matrices within the nth and n−1th codebooks of precoding matrices have unique indicators (alternatively referred to as indices) such that each precoding matrix may be uniquely identified based on its indicator alone. Furthermore, in some embodiments, the method may determine PMI coefficients of the generated PMI upon completion of the OMP processing. The PMI coefficients may be transmitted from the first RTD 300B, 300E to the second RTD 300C, 300F in addition to the PMI, which itself comprises N matrix indicators. Advantageously, by calculating the PMI coefficients after the OMP processing has completed, rather than during the OMP processing, the efficiency with which a PMI is generated is improved.

The OMP processing may further comprise identifying the magnitude of reduction in CSI compression error provided by the nth precoding matrix as an nth CSI error value. In other words, a value indicating the difference between the estimated CSI and the resulting compressed CSI using the nth precoding matrix (in combination with previous matrices identified in the n−1th codebook) is defined as the CSI error value. The CSI error value may be used to terminate the OMP processing when a final PMI should be generated and transmitted from the first RTD 300B, 300E to the second RTD 300C, 300F. For example, the final PMI may be generated when the CSI error value is below a maximum error threshold. The maximum error threshold may be predetermined to be, for example, a value of NMSE less than −40 dB. The final PMI may comprise at least the matrix indicators associated with the suitable precoding matrix. Additionally or alternatively, the final PMI may be generated when a maximum number of N OMP iterations is reached.

In order to aid in the understanding of embodiments of the present disclosure, specific embodiments of generating a PMI for the purpose of in-field AC error evaluation and compensation will now be discussed in relation to FIG. 4. FIG. 4 illustrates a communication system comprising a BS (e.g. the second RTD 300C, 300F) and a UE (e.g. the first RTD 300B, 300E) from a top-level view. The BS (i.e. eNB) comprises plural antennas which transmit reference signals x₁ to x₄ to a UE antenna through multipath fading channels h₁ to h₄. The UE estimates the CSI from received signals y₁ to y₄. The compressed CSI is fed back to the BS as compressed CSI signals g₁ to g₄.

The system of FIG. 4 may be deployed as an enhancement to DL AC in both FDD and TDD systems. Typical Direction-of-Arrival (DOA) based UL AC may be reused to estimate the AC error from the compressed CSI. Advantageously, the system of FIG. 4 addresses the issue introduced by poor accuracy of existing codebook schemes, thereby introducing an enhancement to CSI feedback.

The proposed enhancements may be divided into the following steps:
1. BS sends a Reference Signal (RS) to a UE, such as a CSI-RS.
2. UE estimates the true CSI (i.e. estimated CSI) according to the received RS.
3. The true CSI is compressed by a PMI comprising a plurality of suitable precoding matrices. To reduce the loss of CSI as much as possible, an OMP based PMI selection process is used to identify the suitable precoding matrices. Compared to other algorithms, OMP is much more efficient in terms of computational complexity and power consumption.
4. UE sends the PMI back to BS, as well as their corresponding coefficients. The coefficients are quantised accordingly to reduce the overhead in the feedback channel.
5. BS estimates the AC error by the CSI feedback. In this step, a DOA based AC algorithm is utilised to estimate the AC error from the radio channels identified by the compressed CSI. Once the AC error is given, BS may use it to evaluate the accuracy of AC function, or to compensate it directly.

The system of FIG. 4 may be adjusted to be fully compliant with current 3GPP specification.

A more detailed description of the system is provided below.

The BS sends a reference signal to the UE. The UE estimates the true CSI (e.g. the estimated CSI) and compresses the estimated CSI using a set of precoding matrices defined in a PMI. The UE feeds precoding matrix indices included in the PMI (and their coefficients) back to the BS. The BS estimates an AC error according to the compressed CSI fed back from the UE. Finally, the BS evaluates or compensates the AC error based on the compressed CSI. The details of downlink (DL) AC according to the present disclosure may be described as follows:
1. BS sends a request to the UE to start the procedure.
2. BS adds CSI-RS (e.g. the reference signal) into the DL channel and transmits the reference signal to the UE.
3. UE estimates the TX CSI and executes the OMP processing, then feeds the result back to the BS as the compressed CSI.
4. BS estimates the AC error from the CSI feedback by the proposed DOA based CSI estimation and rotation. If the result is determined to be acceptance, the estimated AC error is used in evaluation or compensation. Otherwise, the estimated AC error is discarded.

Compared with uplink (UL) AC, DL AC has an additional step in which the UE feeds the compressed CSI back to the BS. Except for this step, all other steps are very similar in UL AC and DL AC. For this reason, the following description will emphasis DL AC and a description of UL AC will be omitted for brevity.

### RS Signal and CSI Estimation

In embodiments illustrated by FIG. 4, reference signals (e.g. CSI-RS) may be transmitted between the BS and UE to measure and acquire the CSI, as illustrated in FIG. 4. For example, the BS may send reference signals (e.g. X=[x₁ . . . xₙ]^{T}) to the UE antenna through multiple BS antennas. The UE may receive those reference signals (e.g. Y=[y₁ . . . yₙ]^{T}) propagating through the air at the UE antenna. The radio channel may be expressed as illustrated below in equation (3):

$$Y = H \cdot X + V \qquad ( 3 )$$

where, V is noise, and H is a radio channel. H may include three parts: channel info of the BS (H_{BS}), channel info of the OTA (H_{OTA}) and channel info of the UE (H_{UE}). Hence, H may be estimated as illustrated in equation (4), below:

$$\tilde{H} = Y \cdot {X}^{H} = H + V \cdot {X}^{H} \qquad ( 4 )$$

\tilde{H} is known in the receiver (i.e. the UE in this DL case). However, the UE may be required to send \tilde{H} back to the BS in order for the BS to perform beamforming (i.e. BS in this DL case).

H_{BS} may be compensated by AC in the BS, H_{UE} is neglectable because it's a common phase offset for all BS antennas, and therefore H_{OTA} is the estimated CSI to be expressed by a PMI.

### OMP Based PMI Selection

In embodiments such as that illustrated by FIG. 4, once CSI estimation is done, the UE compresses the estimated CSI before feeding it back to the BS. Type I codebook is not suitable for compressing the CSI with acceptable precision. Therefore, to compress the estimated CSI as precisely as possible, type II codebook is used. Type II codebook contains a set of precoding matrices with a linear combination. However, the precoding matrices in type II codebook are not orthogonal between each other. This means it may be difficult to identify the optimal combination of desired precoding matrices. The number of matrices in one type II codebook may be represented as 4N₁O₁×N₂O₂. For example, for an N₁=4, N₂=4 antenna array, the oversampling rates may be O₁=4 and O₂=4. Accordingly, there may be 1024 matrices in the type II codebook. To find out L=4 optimal precoding matrices, a Maximum Likelihood Estimator (MLE) needs to perform 1024/4 comparisons, which is prohibitive in a real system.

Accordingly, Orthogonal Matching Pursuit (OMP) processing may be introduced for selecting precoding matrices for a PMI. In each step of the OMP processing, an OMP algorithm may select the best-so-far matrix in the type II codebook. A key concept of OMP processing is in the orthogonalisation. That is, after selecting the best-so-far matrix, all remaining precoding matrices may be projected onto the orthogonal space of selected precoding matrix. This may remove the impact of selected precoding matrices when identifying subsequent matrices. At the same time, the contribution of the selected precoding matrix may be subtracted from the residual error. By doing so, the residual error may converge to a minimal point. The OMP processing may be a modification of a conventional OMP algorithm. Some differences in the OMP processing compared to a conventional OMP algorithm may be described as follows:
1. A candidate matrix may be constructed from a standards-compliant codebook (e.g. type II codebook). Therefore, only a matrix that is compliant to standards will be selected.
2. A residual error may be constructed from the estimated CSI. The residual error is constructed by searching the candidate matrix in the beam-space to find out the best approximation.
3. An output of the OMP processing may be a PMI containing a plurality of indicators that represent indices of selected precoding matrices. No original matrices are needed in the output.
4. PMI coefficients may be computed after the OMP processing, not during the OMP processing. The step of coefficient computation may thus be avoided thereby reducing processing load.
5. Because of 4, only the current selected matrix may be involved in a single iteration of the OMP processing. This may significantly reduce processing complexity because the dimension of a candidate matrix may be much smaller than the dimension of all previous selected matrices.

### OMP Processing Description

Assuming the codebook C as C=[w₀ w₁ . . . w_{4N}_{₁}_{O}_{₁}_{N}_{₂}_{O}_{₂}₋₁], the optimal precoding matrices to generate suitable PMI may be searched for the whole codebook C. However, since two polarisations are combined by QPSK, it may be better to search on one of two polarisations, then search on QPSK. As a result, the complexity may be reduced from 4NO₁×N₂O₂ to NO₁×N₂O₂+4. The codebook of one polarisation may be denoted as C=[w_{r,0} w_{r,1} . . . w_{r,N}_{₁}_{O}_{₁}_{N}_{₂}_{O}_{₂}₋₁], where r equals 0 or 1. Meanwhile, the estimated CSI of polarisation r may be denoted as \tilde{h}ᵣ. The OMP processing may be described by Algorithm 1, below.

### Algorithm 1: OMP Based PMI Selection

1. At iteration i=0, the remaining codebook may be initialised as Zᵢ₌₀=Cᵣ, and the residual error as eᵢ₌₀=\tilde{h}ᵣ, and the candidate PMI set Pᵢ₌₀ as an empty matrix.

Without loss of generalisation, the remaining codebook can be expressed as Zᵢ=[z_{i,0} z_{i,1} . . . z_{i,M}_{ᵢ}₋₁]. The number of matrices Mᵢ may be initialised with Mᵢ₌₀=N₁O₁N₂O₂, while its value may be decreased as the algorithm goes on.

2. For iteration i:
a) Find the best-so-far matrix in the remaining codebook

$${l}^{*} = {arg max}_{l} ‖ {z}_{i - 1 , l}^{H} {e}_{i - 1} ‖$$

b) Add the best-so-far matrix z_{i,l*} into the candidate PMI

$${P}_{i} = [ \begin{matrix}{P}_{i - 1} & {z}_{i - 1 , {l}^{*}}\end{matrix} ]$$

c) Subtract the contribution of the selected precoding matrix (i.e. in the updated PMI) from the residual error

$${e}_{i} = {e}_{i - 1} - {z}_{i - 1 , {l}^{*}} ( {z}_{i - 1 , {l}^{*}}^{H} {e}_{i - 1} )$$

d) Project the remaining codebook onto the orthogonal space which includes the selected precoding matrix

$${Z}_{i - 1} = {Z}_{i - 1} - {z}_{i - 1 , {l}^{*}} ( {z}_{i - 1 , {l}^{*}}^{H} {Z}_{i - 1} )$$

e) Remove z_{i-1,l*} from Zᵢ₋₁

$${Z}_{i} = [ \begin{matrix}{z}_{i - 1 , 0} & … & {z}_{i - 1 , {l}^{*} - 1} & {z}_{i - 1 , {l}^{*} + 1} & … & {z}_{i - 1 , {M}_{i - 1}}\end{matrix} ]$$

f) Update i=i+1

3. Repeat 2 until i=L, or the residual error is smaller than a threshold.

For type II codebook, L may be configured up to 4. However, since the AC error may be more randomly distributed, a larger value for L may be used.

### Quantisation of Coefficients

In embodiments illustrated by FIG. 4, after the best precoding matrices have been selected for generating the suitable precoding matrices P_{L}, the PMI coefficients may be calculated using Least Squares (LS) equations, as illustrated by equation (5), below:

$${c}_{r , l} = {( {P}_{L}^{H} {P}_{L} )}^{- 1} {P}_{L} {\tilde{h}}_{r} \qquad ( 5 )$$

where c_{r,l}=[c_{r,l,0} c_{r,l,1} . . . c_{r,l,L-1}]^{T}, and P_{L}=[p₀ p₁ . . . p_{L-1}], the precoding matrix is the linear combination of multiple precoding matrices, which is given by equation (6), as follows:

$${w}_{r , l} = {\sum }_{i = 0}^{L - 1} {p}_{r , l , i} {c}_{r , l , i} \qquad ( 6 )$$

In addition to the indices for selected PMI, the UE may also send the PMI coefficients back to the BS.

Noteworthily, c_{r,l,i} is a complex number, which may be expressed as amplitude A_{r,l,i} and phase θ_{r,l,i}. However, to describe AC error with satisfied accuracy, larger number of bits for A_{r,l,i} and θ_{r,l,i} may be used.

### Simulation Results

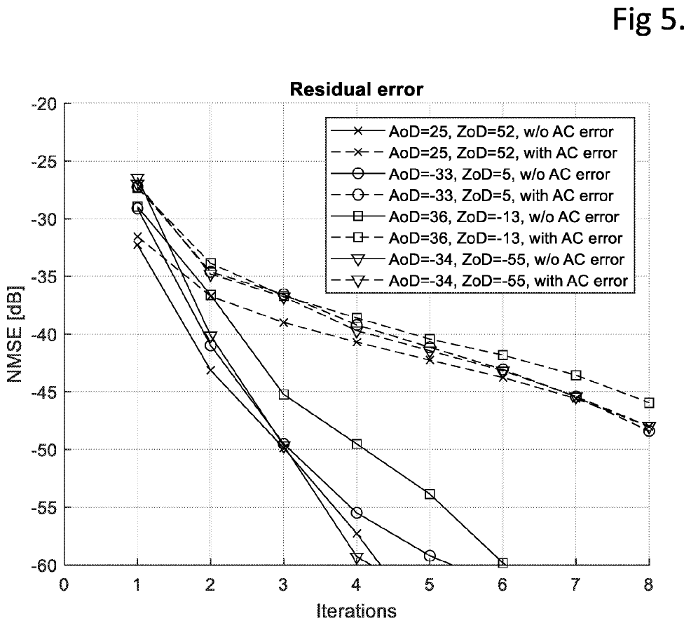

The results of simulations performed for the system illustrated in FIG. 4 are illustrated in FIGS. 5 to 7. A description of these simulation results will now be provided. In FIGS. 5 to 7, the following abbreviations are used: azimuth of departure (AoD) and zenith of departure (ZoD).

FIG. 5 illustrates the normalised mean square error (NMSE) of residual error after precoding matrices selection in the case of no AC error and a small AC error of 22 degrees. The requirement of NMSE is NMSE<−40 dB. When the AC error doesn't exist (i.e. 0 degrees), L=3 is enough to fulfil this requirement of NMSE<−40 dB. Nevertheless, if an AC error does exist (e.g. 22 degrees), larger L may be required. In the simulation of FIG. 5, the three-sigma value of AC error is assumed to be 22 degree, which is common for AC function without failures. In the case where the AC error is 22 degrees, L=5 is enough to fulfil the requirement of NMSE<−40 dB. In the graph illustrated in FIGS. 5, the x-axis indicates number of iterations, and the y-axis indicates NMSE in dB.

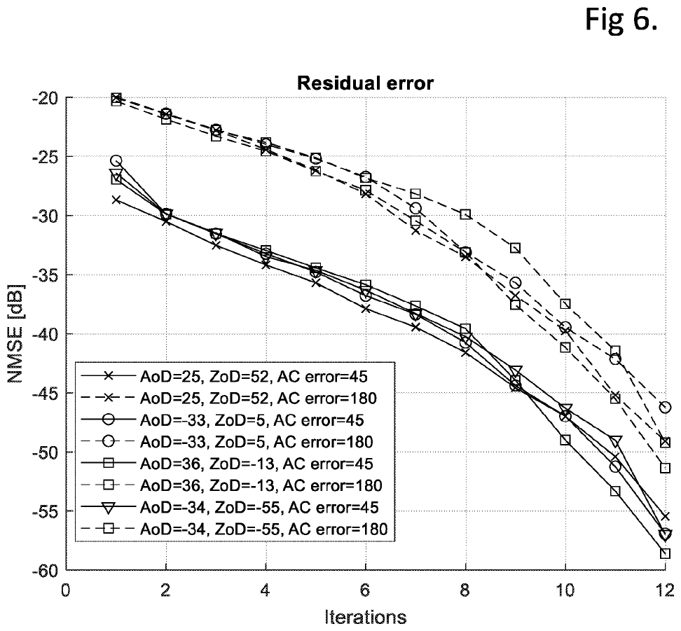

The system of FIG. 4 may be applied even if the AC function has failures (e.g. where there may be large AC error in the AAS product). The results of a simulation in which the AC function has large AC errors is illustrated in FIG. 6. Since the AC error shows more randomness, a larger value for L may be required. For example, if the 3-sigma value of AC error is 45 degree, a value of L=9 may be used, or if the 3-sigma value of AC error is 180 degree, a value of L=11 may be used. In the graph illustrated in FIGS. 6, the x-axis indicates number of iterations, and the y-axis indicates NMSE in dB.

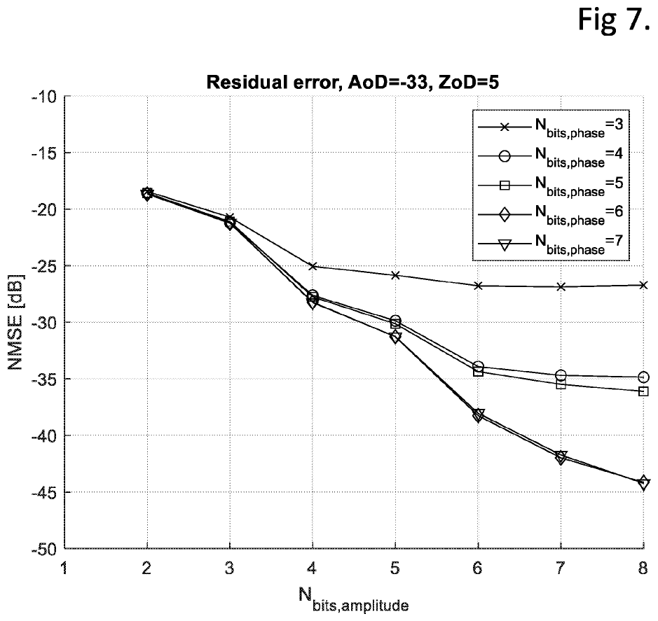

In FIG. 7, the impact of quantisation of A_{r,l,i} and θ_{r,l,i} is simulated. The number of bits for A_{r,l,i} is denoted as N_{bits,amplitude}, and the number of bits for θ_{r,l,i} is denoted as N_{bits,phase}. PSK may be used for phase quantisation. In the simulation of FIG. 7, the following assumptions are made AoD=−33°, ZoD=5°, and AC error=180°, which is a typical fading channel with large initial AC error. FIG. 7 illustrates that to have NMSE<−40 dB, N_{bits,amplitude}=7 and N_{bits,phase}=6 are used. In the graph illustrated in FIGS. 7, the x-axis indicates N_{bits,amplitude} and the y-axis indicates NMSE in dB.

Unlike typical type II codebook that needs to track channel variation due to UE mobility, the system of FIG. 4 may only need to track the AC error variation due to AAS working status, such as temperature or output power. Normally, this variation doesn't change quickly over time, and therefore periodicity in the scale of minutes may be sufficient to track the variation. Hence, the potential overhead increased by this enhancement is mitigated.

### AC Error Estimation

In embodiments illustrated by FIG. 4, when the BS receives the compressed CSI from the UE, the BS may then estimate AC error by leveraging the different patterns of CSI due to propagation channel and AC error. In general, the compressed CSI contains line of sight (LOS)+none-line-of-sight (NLOS)+AC error. By using DOA-based CSI estimation, the CSI may be separated into (LOS) and (NLOS+AC error).

The residual AC error may suffer from the impairment of NLOS. Fortunately, there are ways to mitigate such impairment, for example using algorithms such as maximum coherence combining, where the incoming signals of LOS from different users are coherently combined and the incoming signals of NLOS from different users cancel each other. For this reason, the resulting impairment of NLOS is significantly mitigated.

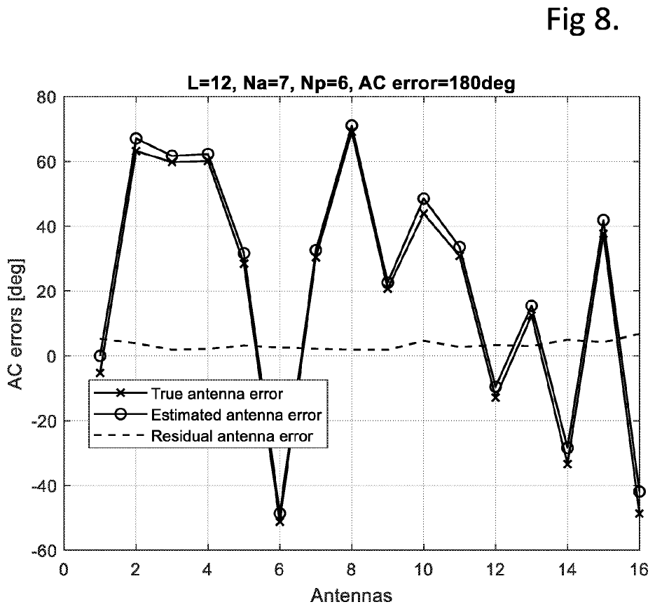

FIG. 8 is a graph illustrating estimated AC error in a case where AoD=−33°, ZoD=5° and the initial AC error=180°, which is a case where the AC function has severe problems and must be fixed. To provide highly accurate compressed CSI, L may be configured as L=12 (as illustrated in FIG. 6), N_{bits,amplitude}=7, and N_{bits,phase}=6 (as illustrated in FIG. 7). The graph of FIG. 8 illustrates that the system of FIG. 4 may achieve good AC error estimation even if the initial AC error is very large. In the graph illustrated in FIGS. 8, the x-axis indicates number of antennas, and the y-axis indicates AC errors in degrees (i.e. [deg]).

Once the AC error is obtained, the BS may use it to evaluate the performance of the AC function. A system failure may be triggered if the AC error is greater than the threshold. In this case, the system of FIG. 4 may work in the mode of “in-field AC function evaluation”. Furthermore, the BS may compensate the result directly to suppress the AC error. In this case, the system of FIG. 4 may work in the mode of “in-field AC function refinement”. The residual AC error illustrated in FIG. 8 may be treated as an estimate error.

The following advantages are provided by the present disclosure. Enabling in-field AC validation, evaluation and compensation in scenarios where radio distribution network (RDN) AC or mutual coupling (MC) AC is not valid. Providing end-to-end solutions with highly accurate results in TDD and/or FDD systems. Reducing the cost for radio products. Relaxing the requirements on MIMO channels while improving beamforming performance. Avoiding the need for any dedicated hardware. Enhancing existing TX CSI feedback techniques. Reducing the overhead requirements for feedback resources (i.e. in an UL channel). Improving resilience within systems due to the impairment of NLOS paths. Improving overall system performance without interrupting normal traffic data.

It will be understood that the detailed examples outlined above are merely examples. According to embodiments herein, the steps may be presented in a different order to that described herein. Furthermore, additional steps may be incorporated in the method that are not explicitly recited above. For the avoidance of doubt, the scope of protection is defined by the claims.

1. A method of precoding matrix indicator, PMI, generation for channel state information, CSI, compression in a communication system comprising a first radio transceiver device, RTD, and a second RTD, the method comprising:
transmitting, from the second RTD to the first RTD, a reference signal;
receiving, at the first RTD from the second RTD, the reference signal;
estimating, at the first RTD, CSI based on the received reference signal;
generating, at the first RTD, a PMI to perform CSI compression, wherein the PMI indicates a precoding matrix, selected from among a codebook of precoding matrices, based on orthogonal matching pursuit, OMP, processing of the estimated CSI;
generating, at the first RTD, a compressed CSI based on the generated PMI for transmission to the second RTD;
transmitting the compressed CSI from the first RTD to the second RTD; and
receiving, at the second RTD from the first RTD, the compressed CSI.

2. The method according to claim 1, wherein the OMP processing comprises:
identifying a suitable precoding matrix, from among the codebook of precoding matrices, which provides the smallest CSI compression error.

3. The method according to claim 2, wherein identifying the suitable precoding matrix, from among the codebook of precoding matrices, comprises:
correlating the estimated CSI with each precoding matrix from among the codebook of precoding matrices,
for each correlated precoding matrix, determining a magnitude of CSI compression error provided by that correlated precoding matrix, and
identifying the precoding matrix which provides the smallest CSI compression error, based on the determined magnitudes, as the suitable precoding matrix.

4. The method according to claim 2, wherein the OMP processing comprises:
updating the PMI to comprise a matrix indicator associated with the suitable precoding matrix.

5. The method according to claim 2, wherein the OMP processing further comprises:
generating an updated codebook of precoding matrices by removing the suitable precoding matrix from the codebook.

6. The method according to claim 5, wherein generating the updated codebook of precoding matrices further comprises:
projecting precoding matrices remaining in the updated codebook, after the suitable precoding matrix has been removed, onto the identified suitable precoding matrix.

7. The method according to claim 2, wherein the OMP processing further comprises:
projecting the estimated CSI onto the identified suitable precoding matrix.

8. The method according to claim 5, wherein the projecting is performed by a projection matrix generated from the identified suitable precoding matrix.

9. The method according to claim 3, wherein the OMP processing further comprises:
identifying the magnitude of CSI compression error provided by the suitable precoding matrix as a CSI error value.

10. The method according to claim 9, wherein the OMP processing further comprises:
generating a final PMI if the CSI error value is below a maximum error threshold.

11. The method according to claim 1, wherein the OMP processing comprises N processing iterations, where N is a positive integer, and wherein each nth iteration of the OMP processing comprises:
identifying an nth precoding matrix, from among the precoding matrices in an n−1th codebook of precoding matrices, which provides the greatest reduction in CSI compression error when combined with previously identified precoding matrices, and
generating an nth codebook of precoding matrices by removing the nth precoding matrix from the n−1th codebook.

12. The method according to claim 11, wherein identifying the nth precoding matrix, from among the n−1th codebook of precoding matrices, comprises:
correlating the estimated CSI with each precoding matrix in the n−1th codebook of precoding matrices,
determining a magnitude of reduction is CSI compression error provided by each correlated precoding matrix when combined with previously identified precoding matrices, and
identifying the nth precoding matrix as the correlated precoding matrix that provides the greatest reduction in CSI compression error when combined with previously identified precoding matrices, based on the determined magnitudes.

13. The method according to claim 11, wherein each nth iteration of the OMP processing further comprises:
updating the PMI to further comprise an nth matrix indicator associated with the nth precoding matrix.

14. The method according to claim 11, wherein generating the nth codebook of precoding matrices further comprises:
projecting the precoding matrices remaining in the nth codebook, after the nth precoding matrix has been removed, onto the identified nth precoding matrix.

15. The method according to claim 11, wherein each nth iteration of the OMP processing further comprises:
projecting the estimated CSI onto the identified nth precoding matrix.

16. The method according to claim 14, wherein the projecting is performed by a projection matrix generated from the identified nth precoding matrix.

17. The method according to claim 12, wherein each nth iteration of the OMP processing further comprises:
identifying the magnitude of reduction in CSI compression error provided by the nth precoding matrix as an nth CSI error value.

18. The method according to claim 17, wherein each nth iteration of the OMP processing further comprises generating a final PMI if at least one of:
the nth CSI error value is below a maximum error threshold, and
a maximum number of N iterations is reached.

19. The method according to claim 1, wherein the method further comprises:
determining, at the first RTD, PMI coefficients of the generated PMI upon completion of the OMP processing.

20-26. (canceled)

27. A communication system comprising a first radio transceiver device, RTD, and a second RTD, the communication system configured to generate a precoding matrix indicator, PMI, for channel state information, CSI, compression, the first RTD comprising processing circuitry and a memory containing instructions executable by the processing circuitry, whereby the first RTD is operable to:
receive, from the second RTD, a reference signal;
estimate CSI based on the received reference signal;
generate a PMI to perform CSI compression, wherein the PMI indicates a precoding matrix, selected from among a codebook of precoding matrices, based on orthogonal matching pursuit, OMP, processing of the estimated CSI;
generate a compressed CSI based on the generated PMI for transmission to the second RTD; and
transmit the compressed CSI to the second RTD, and
the second RTD comprising processing circuitry and a memory containing instructions executable by the processing circuitry, whereby the second RTD is operable to:
transmit, to the first RTD, the reference signal; and
receive, from the first RTD, the compressed CSI.

28-30. (canceled)
